(19) United States
(12) Patent Application Publication
(10) Pub. No.: US 2015/0317315 A1
(43) Pub. Date: Nov. 5, 2015

(54) METHOD AND APPARATUS FOR RECOMMENDING MEDIA AT ELECTRONIC DEVICE

(71) Applicant: Samsung Electronics Co., Ltd., Gyeonggi-do (KR)

(72) Inventors: Jinhe Jung, Gyeonggi-do (KR); Gongwook Lee, Gyeonggi-do (KR); Junho Lee, Gyeonggi-do (KR); Ikhwan Cho, Gyeonggi-do (KR)

(21) Appl. No.: 14/701,330

(22) Filed: Apr. 30, 2015

(30) Foreign Application Priority Data
Apr. 30, 2014 (KR) 10-2014-0052368

(51) Int. Cl. G06F 17/30

(52) U.S. Cl. CPC G06F 17/3053; G06F 17/30554; G06F 17/30312

(57) ABSTRACT

A method and apparatus for recommending media in response to a text input at an electronic device are provided. In the method, the electronic device displays a text input, compares the text input with media stored in a media descript database, and displays recommended media corresponding to the text input from among the stored media. When the displayed recommended media is selected, the electronic device receives the displayed recommended media as an input.

### CROSS-REFERENCE TO RELATED APPLICATION AND CLAIM OF PRIORITY

The present application is related to and claims priority from and the benefit under 35 U.S.C. §119(a) of Korean Patent Application No. 10-2014-0052368, filed on Apr. 30, 2014, which is hereby incorporated by reference for all purposes as if fully set forth herein.

### TECHNICAL FIELD

Various embodiments of the present disclosure relate to recommendation of user-oriented media in response to a text input at an electronic device.

### BACKGROUND

Nowadays a great variety of electronic devices have been widely utilized. For example, when a message is transmitted or received, an electronic device receives input data through an input window. Such input data are images, videos, voice files, emoticons, stickers, etc. as well as text.

When a text input is entered, a typical electronic device recommends a specific image corresponding to the text input. However, this recommendation depends on a search in a database that is offered one-sidedly by the electronic device. Therefore, there are limitations on recommendation of various types of images.

### SUMMARY

To address the above-discussed deficiencies, it is a primary object to provide a method and apparatus for offering user-oriented recommended media from a database that stores therein updated media.

Additionally, the electronic device provides a method and apparatus for creating an emotion-rich, information-rich database through user-oriented media.

According to various embodiments of this disclosure, a method for recommending media at an electronic device includes displaying a text input, comparing the text input with media stored in a media descript database (DB), displaying recommended media corresponding to the text input from among the stored media, and receiving the displayed recommended media as an input when the displayed recommended media is selected.

According to various embodiments of this disclosure, an electronic device includes a touch panel configured to detect a text input, a display panel configured to display the text input and recommended media corresponding to the text input, a memory unit configured to store media including the recommended media and also to store media detailed information, and a control unit configured to analyze the media, to describe the media detailed information by analyzing the media, to control the display panel to display the recommended media corresponding to the text input, and to receive the displayed recommended media as an input when the displayed recommended media is selected.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an electronic device for displaying recommended media in accordance with embodiments of the present disclosure;

FIG. 2 illustrates a part of an electronic device for displaying recommended media in accordance with embodiments of the present disclosure;

FIG. 3 illustrates a structure of a media descript database in accordance with embodiments of the present disclosure;

FIG. 4 illustrates a process of creating a media descript database in accordance with embodiments of the present disclosure;

FIG. 5 illustrates a process of analyzing media so as to create a media descript database in accordance with embodiments of the present disclosure;

FIG. 6 illustrates a process of displaying recommended media in accordance with embodiments of the present disclosure;

FIG. 7 illustrates a process of processing an input in accordance with embodiments of the present disclosure;

FIGS. 8A, 8B and 8C illustrate examples of displaying recommended media in accordance with embodiments of the present disclosure;

FIG. 9 illustrates a process of displaying recommended media in accordance with embodiments of the present disclosure; and

FIGS. 10A and 10B illustrate examples of displaying recommended media in accordance with embodiments of the present disclosure.

### DETAILED DESCRIPTION

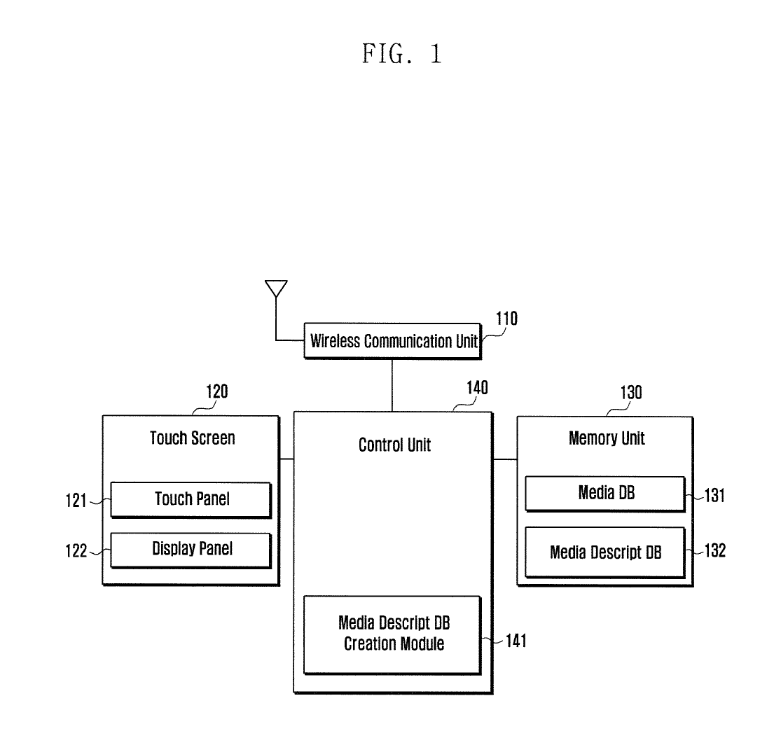

FIGS. 1 through 10B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications system. Hereinafter, the present disclosure will be described with reference to the accompanying drawings. This disclosure is embodied in many different forms and should not be construed as limited to the embodiments set forth herein. Rather, the disclosed embodiments are provided so that this disclosure will be thorough and complete, and will fully convey the scope of the disclosure to those skilled in the art. The principles and features of this disclosure are employed in varied and numerous embodiments without departing from the scope of the disclosure. In addition, descriptions of well-known functions and constructions are omitted for clarity and conciseness.

The term ‘media’ disclosed herein refers to images, videos, emoticons, etc., and also includes media stored in an electronic device, media of the cloud, and media opened in the internet.

FIG. 1 illustrates an electronic device for displaying recommended media in accordance with embodiments of the present disclosure.

Referring to FIG. 1, the electronic device includes, but not limited to, a wireless communication unit 110, a touch screen 120, a memory unit 130, and a control unit 140.

The wireless communication unit 110 includes at least one module capable of a wireless communication between an electronic device and a wireless communication system or between an electronic device and a network in which other electronic device is located. For example, the wireless communication unit 110 includes a cellular communication module, a WLAN (Wireless Local Access Network) module, a short range communication module, a location calculation module, a broadcast receiving module, and the like. According to embodiments of this disclosure, when an application is executed, the wireless communication unit 110 performs a wireless communication.

The touch screen 120 is formed of a touch panel 121 and a display panel 122. The touch panel 121 detects a user input and transmits it to the control unit 140. In certain embodiments, a user inputs an input request using a finger or a touch input tool such as an electronic pen. The display panel 122 displays what is received from the control unit 140. The display panel 122 displays recommended media in response to a text input.

The memory unit 130 includes a media database (DB) 131 and a media descript DB 132. The media DB 131 stores graphic-based media such as images, videos, emoticons, and the like. The media descript DB 132 stores media detailed information corresponding to respective media. In certain embodiments, media detailed information includes information about a description of an object or a correlation between objects displayed on media, information about a location of an object, information about a category of an object, information about a creation date of media, and the like. The media DB 131 and the media descript DB 132 interacts with each other.

The control unit 140 includes a media descript DB creation module 141. The control unit 140 displays recommended media corresponding to a text input through the media descript DB creation module 141. Specifically, when media in the media DB 131 is updated, the control unit 140 analyzes the updated media. At this time, the control unit 140 classifies objects displayed on the media and, when such objects are not classified any more, recognizes each object in the form of specific ID. Additionally, the control unit 140 describes a relation between respective objects. For example, when two objects are displayed on single media (such as an image), such a relation between objects indicates the locations of the respective displayed objects. When an object A is displayed at the left and when another object B is displayed at the right, the relation indicates that the object A is located at the left of the object B and the object B is located at the right of the object A. The control unit 140 stores such a described relation between objects in the media descript DB 132. Also, the control unit 140 describes media detailed information by analyzing media and then store it in the media descript DB 132. Then, when a text input is detected, the control unit 140 compares the text input with media stored in the media descript DB 132. At this time, the control unit 140 compares the text input with media detailed information of the stored media. When any recommended media corresponding to the text input from among media is stored in the media descript DB 132, the control unit 140 displays the recommended media. When one of the displayed recommended media is selected, the control unit 140 receives the selected recommended media as an input.

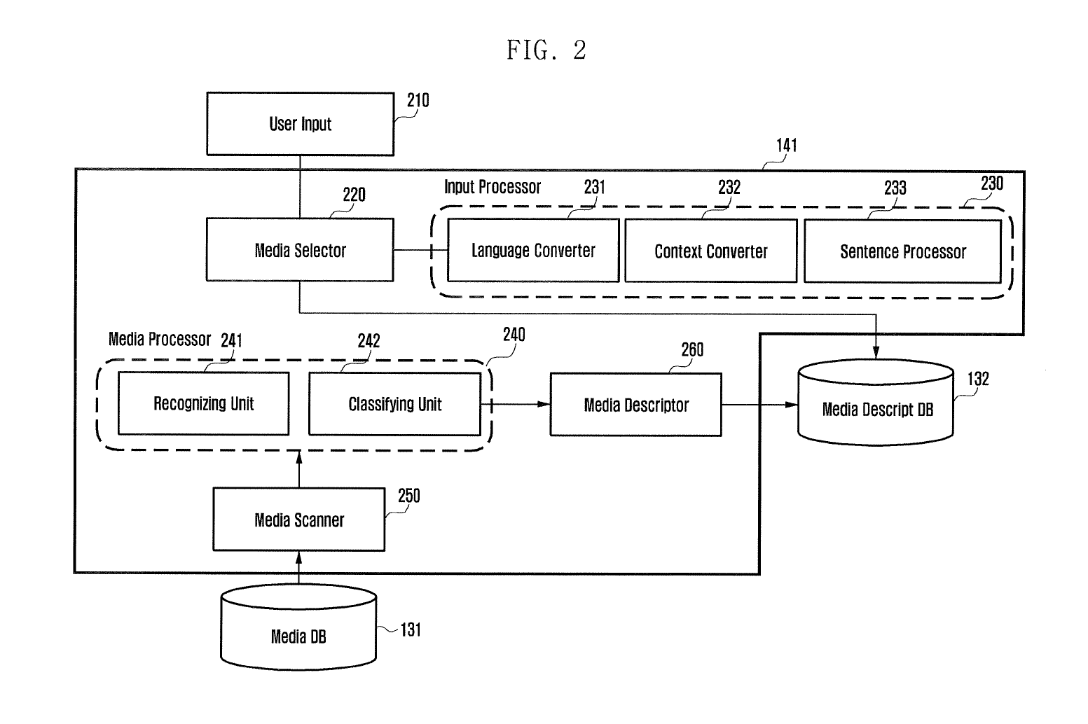

FIG. 2 illustrates a part of an electronic device for displaying recommended media in accordance with embodiments of the present disclosure.

Referring to FIGS. 1 and 2, the media descript DB creation module 141 is configured to include a media selector 220, an input processor 230, a media processor 240, a media scanner 250, and a media descriptor 260.

The media DB 131 stores media such as images, videos, emoticons, and the like. The media DB 131 includes media stored in the electronic device, media of the cloud, and media opened in the internet. Media stored in the media DB 131 is updated, such as modified, deleted, or added.

The media scanner 250 scans continuously the media DB 131. When any media is updated in the media DB 131, the media scanner 250 transmits the updated media to the media processor 240. Like this, the media scanner 250 operates to always maintain an up-to-date media status.

The media processor 240 is configured to include a recognizing unit 241 and a classifying unit 242. When updated media is received from the media scanner 250, the media processor 240 analyzes the received media. At this time, the media processor 240 analyzes at least one object contained in the media. Specifically, the classifying unit 242 classifies displayed objects into categories, and the recognizing unit 241 recognizes each object in the font′ of specific ID so as to guarantee the identity of each object. Category classification is performed stepwise from an upper level to a lower level. For example, when a single object (such as a puppy) is displayed on an image, the classifying unit 242 classifies this object as an animal category and also as a puppy category at a lower level. When there is no lower level, the recognizing unit 241 recognizes this object in the form of specific ID that can guarantee the identity of object in the puppy category. Meanwhile, the media processor 240 transmits media analysis results to the media descriptor 260.

When the media analysis results are received, the media descriptor 260 describes media detailed information and transmit it to the media descript DB 132. When the media detailed information is described, the media descriptor 260 also describes a relation between objects and location information about objects. For example, such location information is coordinate values in the image. Since the media descriptor 260 describes location information about respective objects, the control unit 140 uses only a required part of an object by cutting the object into parts thereof.

The media descript DB 132 stores media detailed information received from the media descriptor 260. In certain embodiments, media detailed information includes information about a description of an object or a correlation between objects displayed on media, information about a location of an object, information about a category of an object, information about a creation date of media, and the like. The media descript DB 132 keeps storing such media detailed information corresponding to each object.

While the media descript DB 132 stores media detailed information, the control unit 140 checks whether a user input 210 occurs. The user input 210 is a text input (such as an addition, modification, deletion, etc.) entered through the touch panel 121.

When the user input 210 occurs, the input processor 230 processes the user input 210 (such as a text input) through a language converter 231, a context converter 232, and a sentence processor 233. The language converter 231 converts an abnormal word into a normal word. For example, when an abnormal word ‘ [symbol] ’ (which is Korean's internet slang typically used as the meaning of laughing) is entered, the language converter 231 converts this into a normal word ‘laughing’. An abnormal word consists of expressions and meanings that are informal and are used by people who know each other very well or who have the same interests. For example, an abnormal word is internet slang, emoticon, or the like. The context converter 232 analyzes context and, when a pronoun or contextual error is found, corrects context. For example, the context converter 232 converts a personal pronoun ‘I’ into a user's name ‘Alice’. The sentence processor 233 corrects an incomplete sentence into a complete sentence. For example, when an incomplete sentence ‘gave a pear to the puppy met yesterday’ is entered, the sentence processor 233 corrects it into a complete sentence ‘I gave a pear to the puppy that I met yesterday’.

After the text input is processed through the input processor 230, the media selector 220 checks whether the recommended media corresponds to the text input in the media descript DB 132. By comparing the text input with media detailed information that contains descriptions about objects, categories of objects, media creation date, etc., the media selector 220 finds recommended media corresponding to the text input. When any recommended media is found as results of comparison, the media selector 220 outputs the recommended media to be displayed and arranges the recommended media on the basis of correlation, degree of recency, and preference.

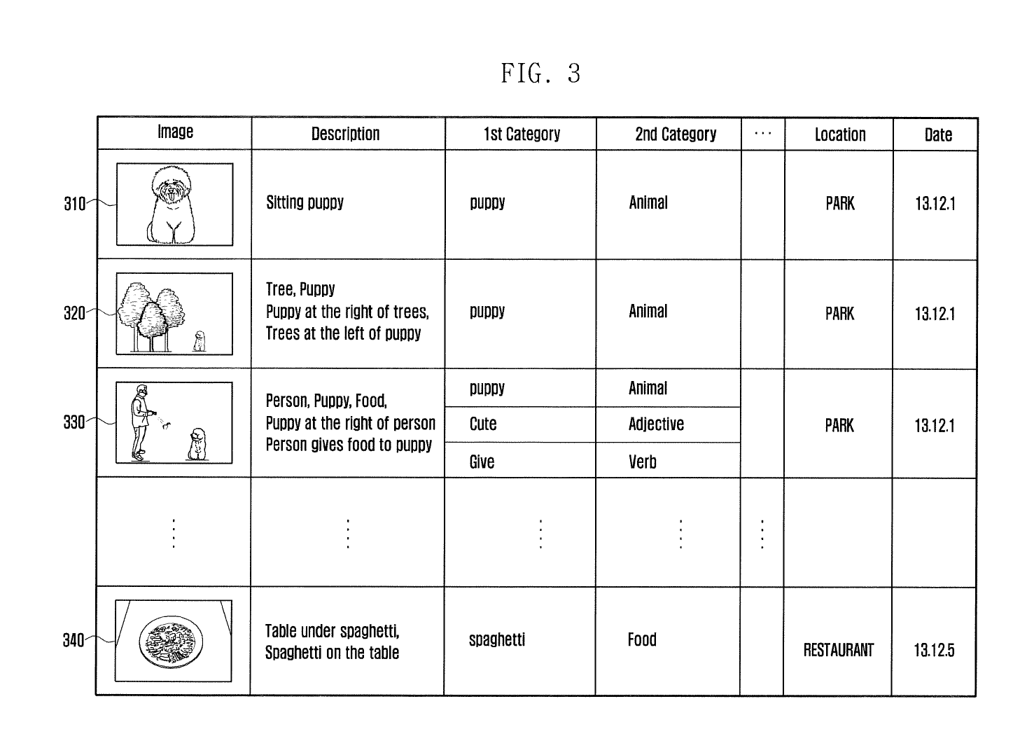

FIG. 3 illustrates a structure of a media descript database in accordance with embodiments of the present disclosure.

Referring to FIG. 3, the control unit 140 controls the media descript DB 132 to store media (such as an image) and media detailed information. In certain embodiments, media detailed information includes information about a description of an object or a correlation between objects displayed on media, information about a location of an object, information about a category of an object, information about a creation date of media, and the like. Object category information is classified stepwise from an upper level to a lower level.

For example, the first image 310 shows a puppy. In certain embodiments, the description field, the first category field (such as a lower level), and the second category field (such as an upper level) records ‘sitting puppy’, ‘puppy’, and ‘animal’, respectively. The second image 320 shows two kinds of objects, such as a tree and a puppy. In certain embodiments, the description field records a correlation between objects, such as a ‘puppy at the right of trees’ or ‘trees at the left of puppy’. The third image 330 shows three kinds of objects, i.e., a person, a puppy, and a food. In certain embodiments, the category field records two or more classifications using several parts of speech in English, such as a noun, an adjective, or a verb.

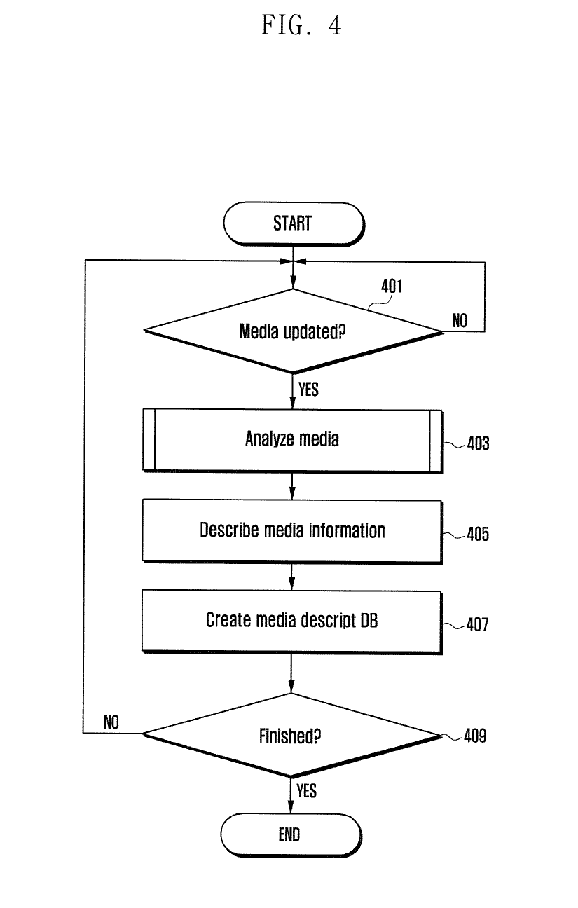

FIG. 4 illustrates a process of creating a media descript database in accordance with embodiments of the present disclosure.

In step 401, the control unit 140 checks, through the media scanner 250, whether media is updated. In certain embodiments, media is graphic-based media such as images, videos, emoticons, and the like. In step 403, when media is updated, the control unit 140 analyzes the updated media through the media processor 240.

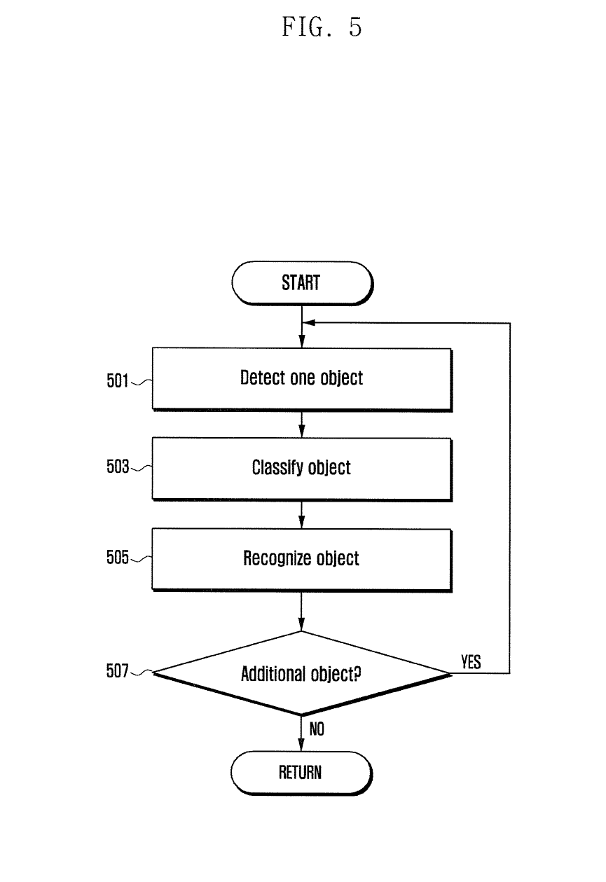

FIG. 5 illustrates a process of analyzing media so as to create a media descript database in accordance with embodiments of the present disclosure.

In step 501, the control unit 140 detects one object. For example, the control unit 140 recognizes preferentially the greatest or centered object. In step 503, the control unit 140 classifies the detected object through the classifying unit 242. For example, when a puppy is detected as one object, the detected puppy is classified as a puppy category at a lower level or an animal category at an upper level. In step 505, the control unit 140 recognizes the object in the form of specific ID through the recognizing unit 241 so as to guarantee the identity of the object. In step 507, the control unit 140 checks whether there are any additional objects. When there is an additional object, the control unit 140 returns to the step 501 to detect the additional object. When there is not an additional object, the control unit 140 returns to the FIG. 4 process at step 403.

In step 405, after analyzing the media as shown in FIG. 5, the control unit 140 describes media detailed information based on the media analysis through the media descriptor 260. The media detailed information includes, as shown in FIG. 3, information about a description of an object or a correlation between objects displayed on media, information about a location of an object, information about a category of an object, information about a creation date of media, and the like. In step 407, the control unit 140 creates the media descript DB 132 that includes the media detailed information. In step 409, the control unit 140 checks whether the creation of the media descript DB 132 is finished. When the creation is not finished, the control unit returns to the above-discussed step 401. When the creation is finished, the process is ended.

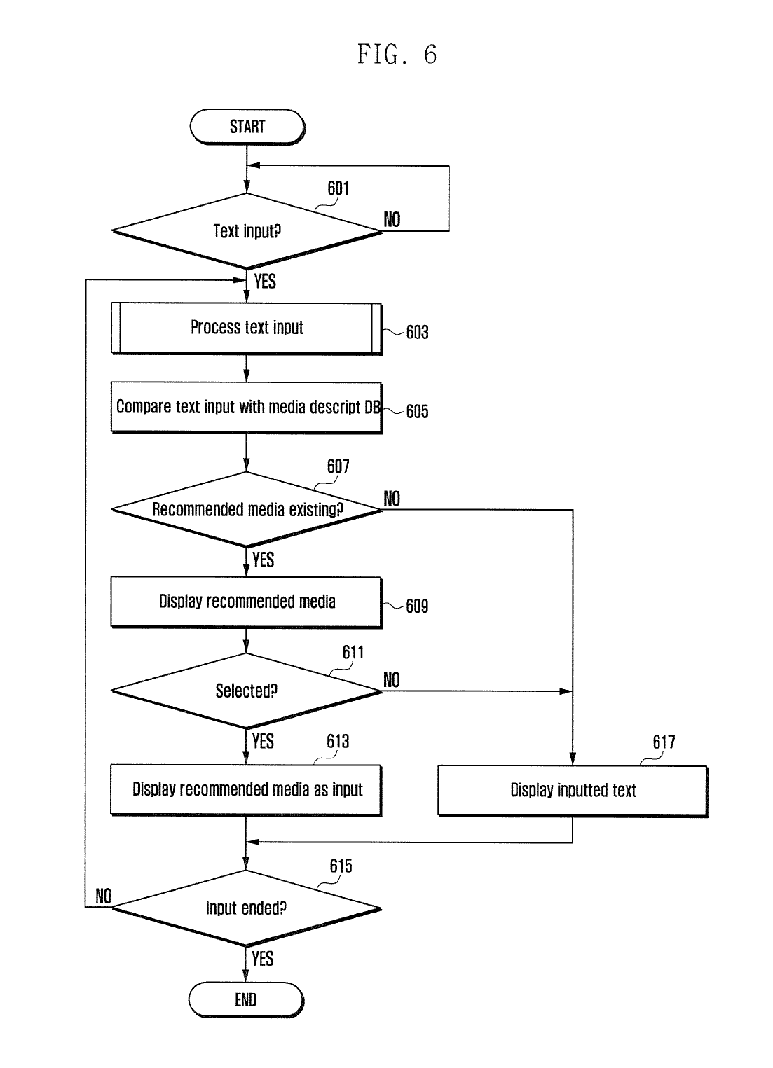

FIG. 6 illustrates a process of displaying recommended media in accordance with embodiments of the present disclosure.

In step 601, the control unit 140 checks whether a text input is entered. In step 603, when text input is entered, the control unit 140 processes the text input through the input processor 230.

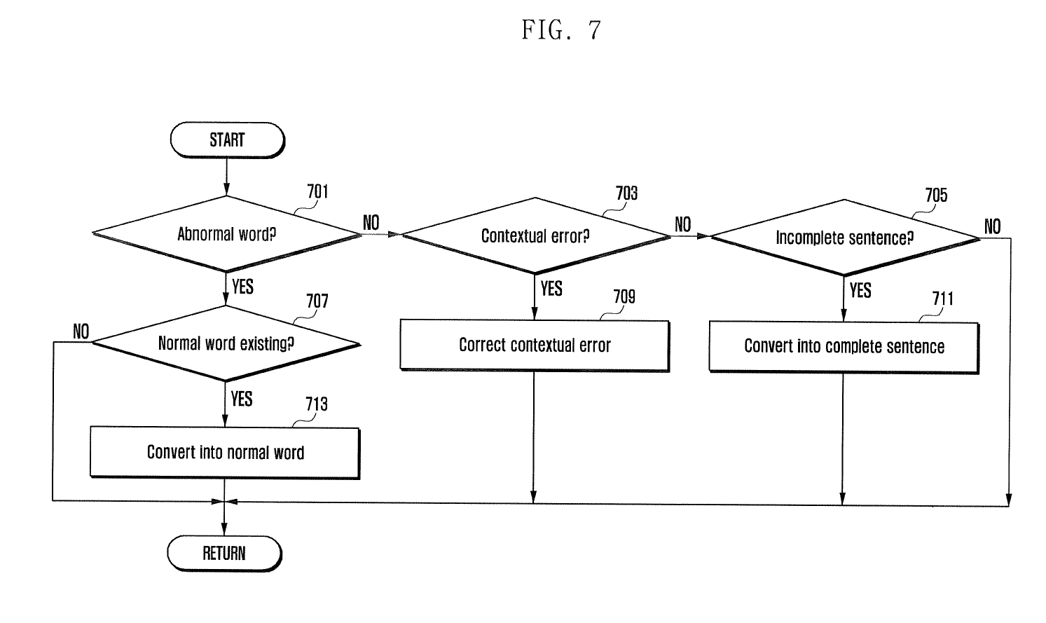

FIG. 7 illustrates a process of processing an input in accordance with embodiments of the present disclosure.

In step 701, the control unit 140 checks whether the text input is an abnormal word. In step 707, when any abnormal word is inputted, the control unit 140 checks whether there is a normal word corresponding to the abnormal word in stored words. In step 713, when there is any normal word corresponding to the abnormal word, the control unit 140 converts the inputted abnormal word into the corresponding normal word. In step 703, when no abnormal word is inputted at step 701, the control unit 140 detects an error in context. In step 709, when there is any error in context, the control unit 140 corrects such an error. Further, when any pronoun is detected, the control unit 140 converts such a pronoun into a corresponding word. In step 705, when there is no error in context, the control unit 140 checks whether the input is an incomplete sentence. In step 711, when the input is an incomplete sentence, the control unit 140 converts the inputted incomplete sentence into a complete sentence. Like this process, the control unit 140 processes the text input.

Returning to FIG. 6, at step 605, the control unit 140 compares the text input with media stored in the media descript DB 132. The control unit compares the text input with media detailed information in the media descript DB 132. The media detailed information includes information about a description of an object or a correlation between objects displayed on media, information about a location of an object, information about a category of an object, and information about a creation date of media. The media descript DB 132 is in a state of interacting with the media DB 131.

In step 607, when the text input is equal to any media detailed information, the control unit 140 determines that recommended media exists. For example, a user enters a text input (such as a puppy). The control unit 140 compares the text input with media detailed information stored in the media descript DB as shown in FIG. 3. Specifically, the control unit 140 performs comparison in category fields (such as a lower-level category field and an upper-level category field). When the text input (such as a puppy) is found in any category field (such as a puppy category), the control unit 140 determines that recommended media exists corresponding to the text input. In step 609, the control unit 140 displays the recommended media.

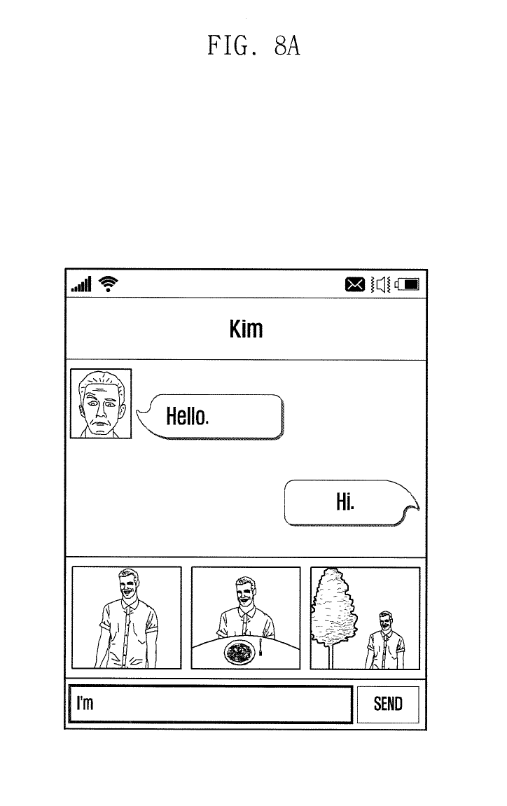

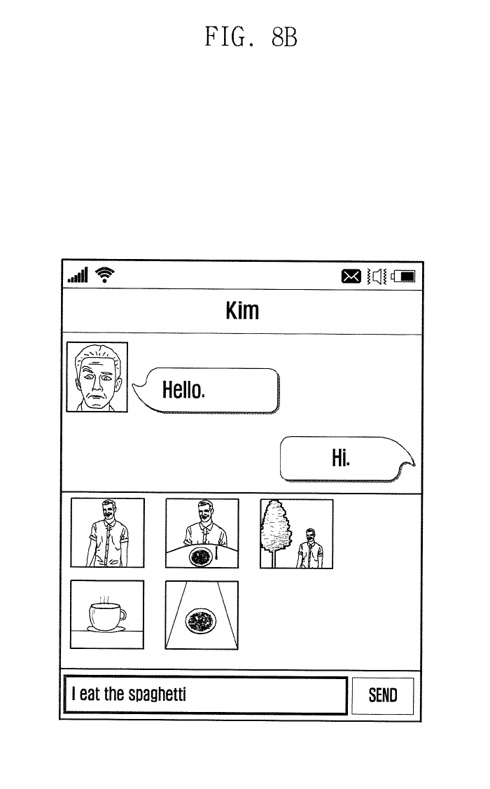

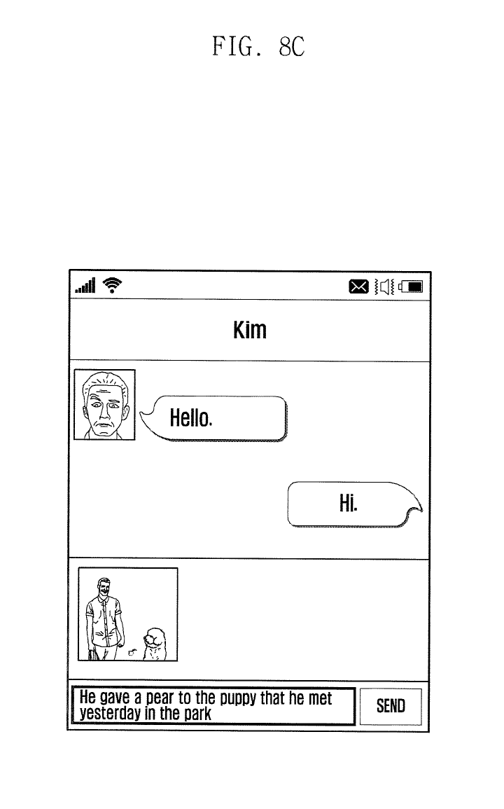

FIGS. 8A to 8C illustrate examples of displaying recommended media in accordance with embodiments of the present disclosure.

FIG. 8A shows an example of displaying recommended media corresponding to a word when the text input is a word. For example, when text ‘I'm’ is entered, the control unit 140 retrieves at least one recommended media corresponding to a user and then display the corresponding recommended media to be arranged on the basis of correlation, degree of recency, and preference. The control unit 140 extracts a specific part only, which corresponds to a user (such as an object T), from the retrieved media (such as an image) and displays only the specific part. Since media detailed information includes information about locations of objects, the control unit 140 extracts and displays only a specific part corresponding to a specific object.

FIG. 8B shows an example of displaying recommended media corresponding to a word or a sentence when the text input is a sentence. For example, when a sentence ‘I ate the spaghetti’ is entered, the control unit 140 retrieves recommended media corresponding to ‘I’, recommended media corresponding to ‘spaghetti’, and recommended media corresponding to both ‘I’ and ‘spaghetti’ and displays all of the retrieved media to be arranged.

FIG. 8C shows an example of displaying recommended media corresponding to a sentence when the text input is a sentence. For example, when a sentence ‘He gave a pear to the puppy that he met yesterday in the park’ is entered, the control unit 140 recognizes text inputs ‘he’, ‘gave’, ‘pear’, ‘puppy’, ‘yesterday’, ‘park’, etc., retrieves specific media containing at least one object corresponding to such text inputs in the media detailed infatuation, and displays the retrieved media as recommended media. The more objects included in the text input, the higher the correlation of recommended media is.

Returning again to FIG. 6, at step 611, the control unit 140 checks whether any recommended media is selected from the displayed recommended media by a user or the control unit 140. In step 613, the control unit 140 inputs and displays the selected recommended media. In step 617, when no selection of recommended media is detected, the control unit 140 displays the inputted text. In step 615, the control unit 140 checks whether the text input is ended. In certain embodiments with no end, the control unit 140 returns to the previous step 603.

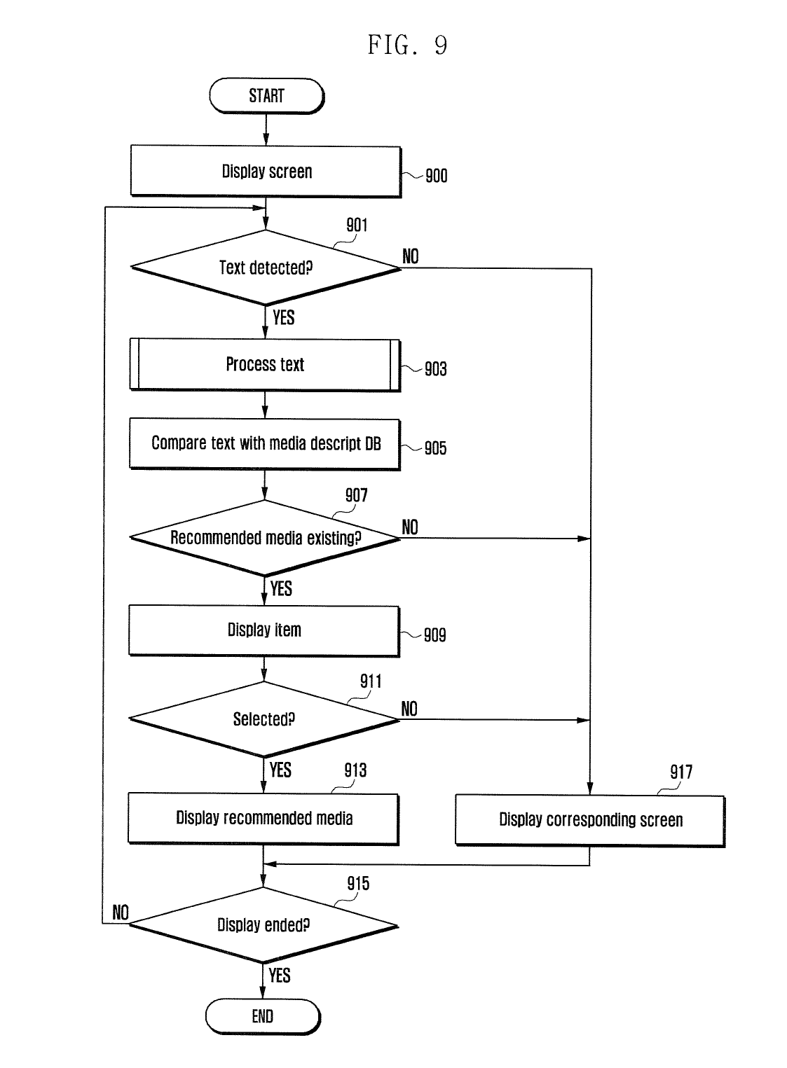

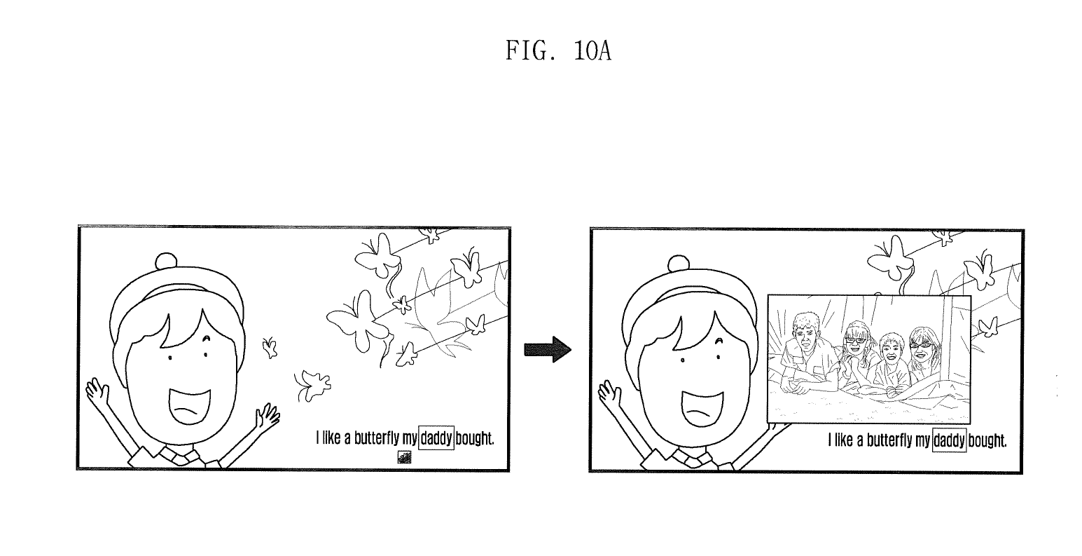

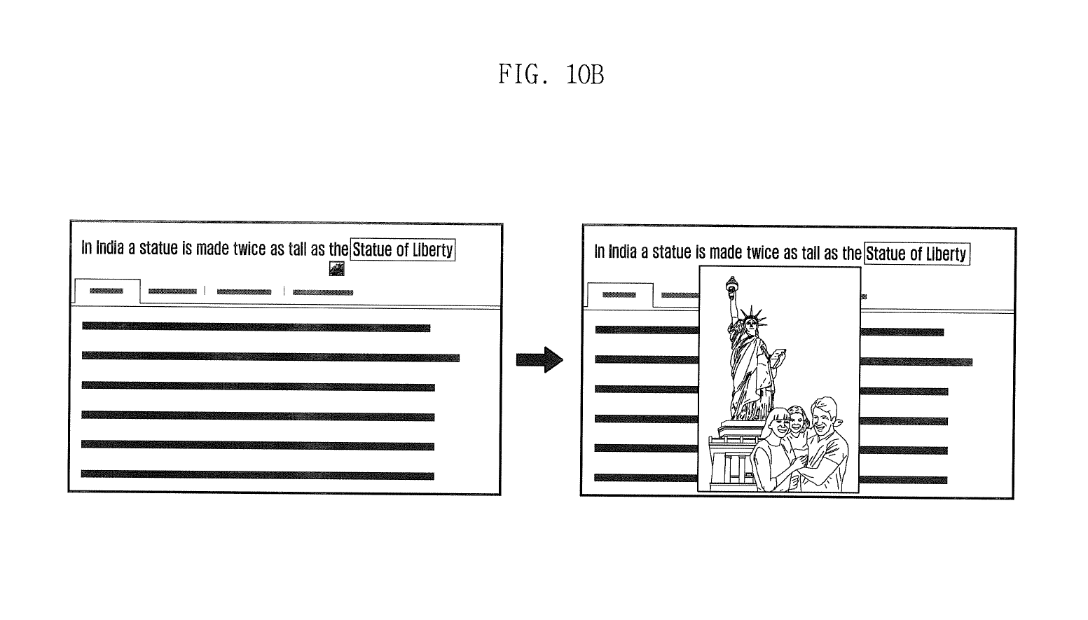

FIG. 9 illustrates a process of displaying recommended media in accordance with embodiments of the present disclosure. FIGS. 10A and 10B illustrate examples of displaying recommended media in accordance with embodiments of the present disclosure.

In step 900, the control unit 140 displays a screen. The screen is a gallery application screen, an internet browser screen, an image viewer screen, or the like. In step 901, the control unit 140 checks whether any text is detected from the displayed screen. In step 903, the control unit 140 processes the detected text through the input processor 230. This process is performed in the same manner as earlier discussed in FIG. 7. In step 905, the control unit 140 compares the text with media stored in the media descript DB 132. In step 907, the control unit 140 determines whether any media corresponding to the text exists. In step 909, when any recommended media corresponding to the text exists, the control unit 140 recognizes and displays a particular item indicating the recommended media. In certain embodiments, this item is a thumbnail of the recommended media corresponding to the text, a specific predefined icon, or the like. In step 911, the control unit 140 checks whether the displayed item is selected. In step 913, when the item is selected, the control unit 140 displays the recommended media corresponding to the text. In step 917, when no item is selected, the control unit 140 displays other predefined screen. For example, the other predefined screen is a screen displaying the inputted text.

FIG. 10A shows an example of detecting specific text ‘daddy’ from a displayed image and displaying recommended media corresponding to the detected text ‘daddy’. Specifically, the control unit 140 compares the detected text ‘daddy’ with media stored in the media descript DB 132. When any recommended media corresponds to the text ‘daddy’, the control unit 140 displays a particular item 1001 indicating the recommended media. When the item 1001 is selected, the control unit 140 displays the recommended media 1002.

FIG. 10B shows an example of detecting specific text ‘Statue of Liberty’ from an internet browser screen and displaying recommended media corresponding to the detected text ‘Statue of Liberty’. When a webpage containing text ‘Statue of Liberty’ is displayed on the internet browser screen, the control unit 140 compares the detected text ‘Statue of Liberty’ with media stored in the media descript DB 132. When any recommended media corresponds to the text ‘Statue of Liberty’, the control unit 140 displays a particular item 1001 indicating the recommended media. When the item 1001 is selected, the control unit 140 displays the recommended media 1003, such as a photo image which contains a user.

Returning to FIG. 9, at step 915, the control unit 140 checks whether a screen display has ended. When a screen display has not ended, the control unit 140 returns to the above-discussed step 900.

As fully discussed hereinbefore, the electronic device according to various embodiments of the present disclosure displays recommended media in response to a text input. When the displayed recommended media is selected, it is entered as an input in the electronic device. The displayed recommended media is retrieved in a user-oriented manner (such as based on a user input) and continuously updated to maintain recency.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for recommending media at an electronic device, the method comprising:
receiving a text input;
comparing the inputted text with a descript of media stored in a media descript database (DB);
identifying at least one recommended media based on the comparing result;
displaying at least one recommended media; and
in response to selecting a recommended media from the displayed at least one recommended media, displaying the selected recommended media.

2. The method of claim 1, wherein the comparing the inputted text with the descript of media includes comparing, if the inputted text is a word, the word with the descript media.

3. The method of claim 1, wherein the comparing the inputted text with the descript of media includes comparing, if the inputted text is a sentence, the respective words or a combination of the respective words in the sentence with the descript of media.

4. The method of claim 1, wherein the media descript DB further stores media detailed information created by analyzing the media.

5. The method of claim 4, wherein the media includes at least one object displayed, and wherein the media detailed information includes at least one of information about a description of each object or a correlation between the objects, information about a location of each object, information about a category of each object, and information about a creation date of the media.

6. The method of claim 4, wherein the comparing of the inputted text with the descript of media includes comparing the inputted text with the media detailed information.

7. The method of claim 1, wherein the receiving the text input includes processing the text input, and wherein the processing includes at least one of converting an abnormal word into a normal word, correcting an error in context, and converting an incomplete sentence into a complete sentence.

8. The method of claim 1, wherein the displaying at least one recommended media includes arranging the recommended media based on at least one correlation, degree of recency, and preference.

9. A method for recommending media at an electronic device, the method comprising:
displaying a screen;
detecting text from the displayed screen;
comparing the detected text with a descript of media stored in a media descript database (DB);
identifying at least one recommended media based on the comparing result;
displaying at least one recommended media; and
in response to selecting a recommended media from the displayed recommended media, displaying the selected recommended media.

10. The method of claim 9, wherein the comparing the inputted text with the descript of media includes comparing, if the detected text is a word, the word with the descript media.

11. The method of claim 9, wherein the comparing the inputted text with the descript of media includes comparing, if the inputted text is a sentence, the respective words or a combination of the respective words in the sentence with the descript of media.

12. An electronic device comprising:
a touch panel configured to detect a text input;
a display panel configured to display the text input and recommended media corresponding to the text input;
a memory unit configured to:
store media including the recommended media; and
store media detailed information; and
a control unit configured to:
analyze the media;
describe the media detailed information by analyzing the media;
control the display panel to display at least one identified recommended media based on comparing result; and
in response to selecting a recommended media from the displayed recommended media, control the display panel to display selected recommended media.

13. The electronic device of claim 12, wherein the memory unit includes a media database (DB) configured to store the media and a media descript DB configured to store the media detailed information.

14. The electronic device of claim 13, wherein the control unit includes:
a media scanner configured to:
scan the media DB; and
when new media is recognized, transmit the new media to a media processor;
the media processor configured to:
receive the new media from the media scanner;
analyze the received media; and
transmit analysis results to a media descriptor;
the media descriptor configured to:
receive the analysis results from the media processor;
describe the media detailed information; and
transmit the media detailed information to the media descript DB; and
a media selector configured to:
find the recommended media corresponding to the inputted text; and
output the recommended media to be displayed.

15. The electronic device of claim 13, wherein the control unit is further configured to compare the inputted text with the media detailed information stored in the media descript DB to find the recommended media.

16. The electronic device of claim 13, wherein the control unit includes an input processor configured to:
perform at least one of converting an abnormal word into a normal word;
correct an error in context; and
convert an incomplete sentence into a complete sentence.

17. The electronic device of claim 13, wherein the control unit is further configured to:
detect text from a displayed screen;
compare the detected text with the descript of media stored in the media descript database; and
identify at least one recommended media based on the comparing result.

18. The electronic device of claim 12, wherein the control unit is further configured to:
if the inputted text is a word, control the display panel to display the recommended media corresponding to the word; and
if the inputted text is entered as a sentence formed of two or more words, control the display panel to display the recommended media corresponds to the respective words or a combination of the respective words in the sentence.

19. The electronic device of claim 12, wherein the media includes at least one object displayed, and wherein the media detailed information includes at least one of information about a description of each object or a correlation between the objects, information about a location of each object, information about a category of each object, and information about a creation date of the media.

20. The electronic device of claim 12, wherein the control unit is further configured to control the display panel to arrange the recommended media based on at least one correlation, degree of recency, and preference.
